(19) United States
(12) Patent Application Publication
(10) Pub. No.: US 2003/0187888 A1
(43) Pub. Date: Oct. 2, 2003

(54) Garbage collection

(76) Inventor: Andrew Hayward, Wallingford (GB)

Correspondence Address: Morgan & Finnegan, 345 Park Avenue, New York, NY, 10154, US

(21) Appl. No.: 10/240,015

(22) PCT Filed: Mar. 28, 2001
(86) PCT No.: PCT/GB01/01375

(30) Foreign Application Priority Data
Mar. 28, 2000 (GB) 0007493.0

(51) Int. Cl. G06F 17/30

(52) U.S. Cl. 707/206

(57) ABSTRACT

A garbage collector, making use of interior pointers, maintains a tree structure comprising a plurality of linked nodes (40-52), each node being representative of a memory allocation (a . . . g). For each known in-use interior pointer (P) the tree is searched to determine the memory allocation (c) to which the pointer points. That memory allocation (c) is noted as being unavailable for garbage collection release. Once all available in-use pointers have been searched for, the system releases those memory allocations which have not been noted as unavailable for release. Preferably, the tree is an AVL tree. The method is applicable to any memory allocation scheme, with no constraints on the size of memory allocations nor their positions in memory. The invention further extends to a method of garbage collection and to an operating system including a garbage collector.

The present invention relates to garbage collection, and particularly although not exclusively to garbage collection within an object-oriented environment.

The expression “garbage collection” relates to the automatic reclamation of computer memory, usually by the operating system, when that memory is no longer required for the program that is being executed. In some languages such as C or C++, memory allocation freeing must be done explicitly by the programmer. In many other languages such as Java (trade mark of Sun Microsystems, Inc.) the programmer is freed from the need to worry about the releasing of memory allocation by means of a garbage collector which runs in the background. Such a garbage collector is part of the Java Virtual Machine (JVM). Objects created by the programmer are automatically destroyed by the garbage collector part of the JVM when no further references to them exist (and hence when they cannot again be accessed by the executing program).

A reference to an object is made when an object O1 contains a pointer or handle to another object O2 whereby O1 can access the fields and the call methods of O2. References to objects can also appear in static (global data) and on the processor stack. Conceptually, in Java, these references refer to an entire object and to no single part of it.

When Java code is compiled into native code, these references may become pointers between data structures (either direct pointers or indirect pointers). Typically, these pointers refer to the start of (that is, the lowest memory address of) a data structure representing an object.

As an optimisation when generating the native code, it may be useful to create a pointer which points to the interior rather than to the start of another data structure. If the garbage collector can recognise these interior pointers as references, then the native code does not have to save the original pointer to the start of the data structure; otherwise, the original pointer needs to be saved, leading to larger code.

Mechanisms for efficiently searching for interior pointers do exist, but these depend upon forcing a particular memory layout: allocations of similar sizes are all made from the same region of memory, starting at a page boundary or a known memory location. Typically, the start memory locations for each of the regions are constant, and all are multiples of a factor of 2. With such an arrangement, the size of the allocation and its start memory can be determined by masking an interior pointer with the inverse of the factor of 2: this gives the pointer to the start of the memory region.

Such prior art approaches to the garbage collection of interior pointers are wasteful of memory since large blocks of memory need to be allocated, even for small objects, to ensure that the memory blocks are properly aligned (for example on a page boundary). Inefficient memory allocation of this type can be particularly damaging when programs are to be run in an embedded environment, such as a handheld computer or a mobile phone.

The further difficulty with conventional garbage collection systems is that they typically depend upon the details of the particular memory allocation scheme that is in use. That may be convenient when the memory allocation is under control of the operating system that is carrying out the garbage collection, as it often is, but it is much less convenient in “hosted” systems in which the operating system that includes the garbage collector is “hosted” on another underlying operating system which controls memory allocation. The fact that different underlying operating systems may use different memory allocation schemes means that different garbage collectors need to be provided in each case. This is not only wasteful of programming effort, it is also inconvenient since it makes it virtually impossible to provide a compact and efficient operating system, including garbage collection capabilities, which can be hosted without amendment on a variety of different underlying operating systems.

It is an object of the present invention at least to alleviate the problems of the prior art.

According to a first aspect of the present invention there is provided a method of garbage collection including:

(a) maintaining a tree structure comprising a plurality of linked nodes, each node being representative of a memory allocation;

(b) for an in-use pointer, searching the tree to determine the memory allocation to which the pointer points; and

(c) noting the said memory allocation as being unavailable for garbage collection release.

The noting of unavailable memory allocations may include marking the memory allocation (if it is not already marked) or the corresponding node on the tree structure. The method of the invention may be used in association with any convenient mechanism for actually releasing unused memory allocations: Preferably, that will include repeating steps (b) and (c) for a plurality of in-use pointers, and releasing those memory allocations which have not been noted as unavailable for release. Preferably steps (b) and (c) are repeated for all in-use pointers, or at least all such pointers which are known to the system.

Preferably, the tree is the binary tree, and is searched from the top using a standard binary traverse. In one particularly convenient embodiment, the tree is an AVL balanced tree. Standard AVL algorithms may be used to restructure the tree to maintain its balanced form whenever a new node is added corresponding to a new memory allocation, or whenever a node is removed corresponding to a memory allocation being released for re-use.

The tree need not necessarily be binary, and the invention is applicable to any N-way tree, as well as to any N-way balanced tree.

Each memory allocation may represent a contiguous memory block and, in object-oriented systems, may represent an individual object. In one form of the invention, the objects may be the compiled forms of Java objects.

Each node may have, associated with it, information on the block start and the block end locations; or on one of the said locations and the block length. The node may also optionally include other memory allocation-related information, for example a block identifier. In order to define the tree structure efficiently, each node preferably also includes the addresses of its parent node (if any) and its child nodes (if any).

The tree structure may be used to search for any type of pointer, including interior pointers.

According to a further aspect of the present invention there is provided a garbage collector including:

(a) means for maintaining a tree structure comprising a plurality of linked nodes, each node being representative of a memory allocation;

(b) means for searching the tree, for an in-use pointer, to determine the memory allocations to which the pointer points; and

(c) means for noting the said memory allocations as being unavailable for garbage collection release.

According to a further aspect of the invention there is provided a method of garbage collection including:

(a) maintaining a tree structure comprising a plurality of linked nodes, each node being representative of a system memory allocation which includes one or more garbage-collectable memory allocations;

(b) for an in-use pointer, searching the tree to determine the garbage-collectable memory allocation to which the pointer points; and

(c) noting the said garbage-collectable memory allocation as being unavailable for garbage collection release.

According to a further aspect of the invention there is provided a garbage collector including:

(a) means for maintaining a tree structure comprising a plurality of linked nodes, each node being representative of a system memory allocation which includes one or more garbage-collectable memory allocations;

(b) means for searching the tree, for an in-use pointer, to determine the garbage-collectable memory allocation to which the pointer points; and

(c) means for noting the said garbage-collectable memory allocation as being unavailable for garbage collection release.

The invention further extends to an operating system and to a JVM (Java Virtual Machine) including a garbage collector as defined.

In one embodiment, the operating system may include memory allocation means so that memory allocation can be controlled as efficiently as possible without any need to introduce artificial constraints on the position in memory of memory allocations. Alternatively, the operating system may not include any memory allocation means, with the garbage collector being arranged to operate with memory allocations which have been externally provided. One example of this is where the operating system of the present invention is hosted on a second, underlying operating system; in such a case, the externally-provided memory allocations are supplied by the memory allocation means of that underlying operating system. Regardless of the memory allocation scheme being applied by the underlying operating system, the garbage collector can still make use of it. A particular advantage of an operating system having a garbage collector which can make use of externally-provided memory allocations is that such an operating system can be hosted on a variety of different underlying systems without any need to worry about the memory allocation scheme used by the underlying system. If the underlying system allocation scheme is efficient, the operating system will take advantage of that.

The invention further extends to a computer program for carrying out a method as described, to a data carrier carrying such a computer program, and to a data stream representative of such computer program. It also extends to a data carrier carrying an operating system as described, and to a data stream representative of such an operating system.

The invention may be carried into practice in a number of ways and one specific embodiment will now be described, by way of example, with reference to the accompanying drawings, in which:

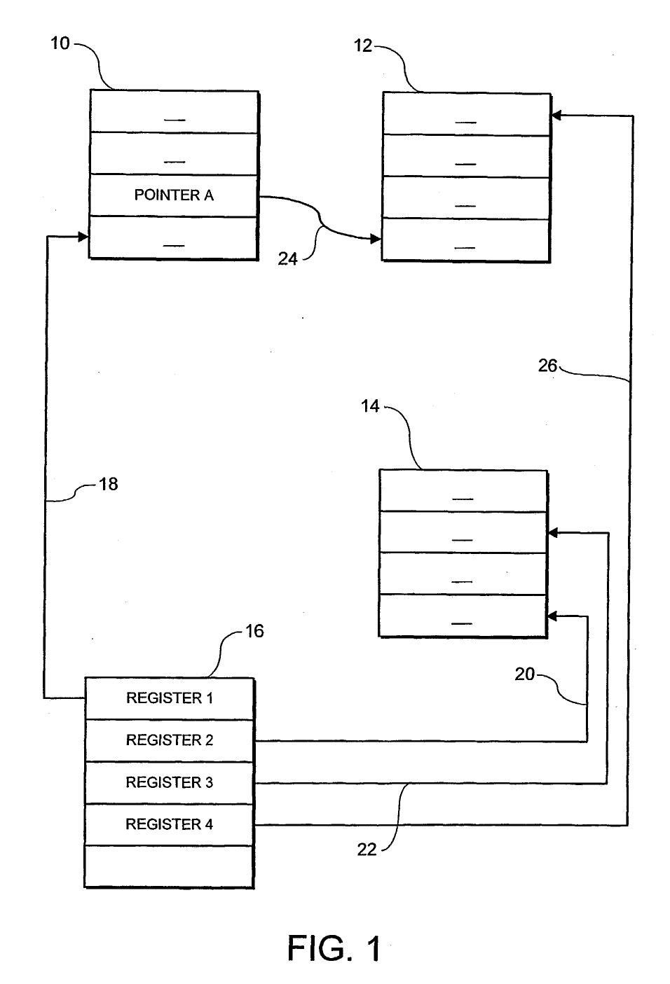

FIG. 1 is a schematic representation showing the use of interior pointers in optimised native code;

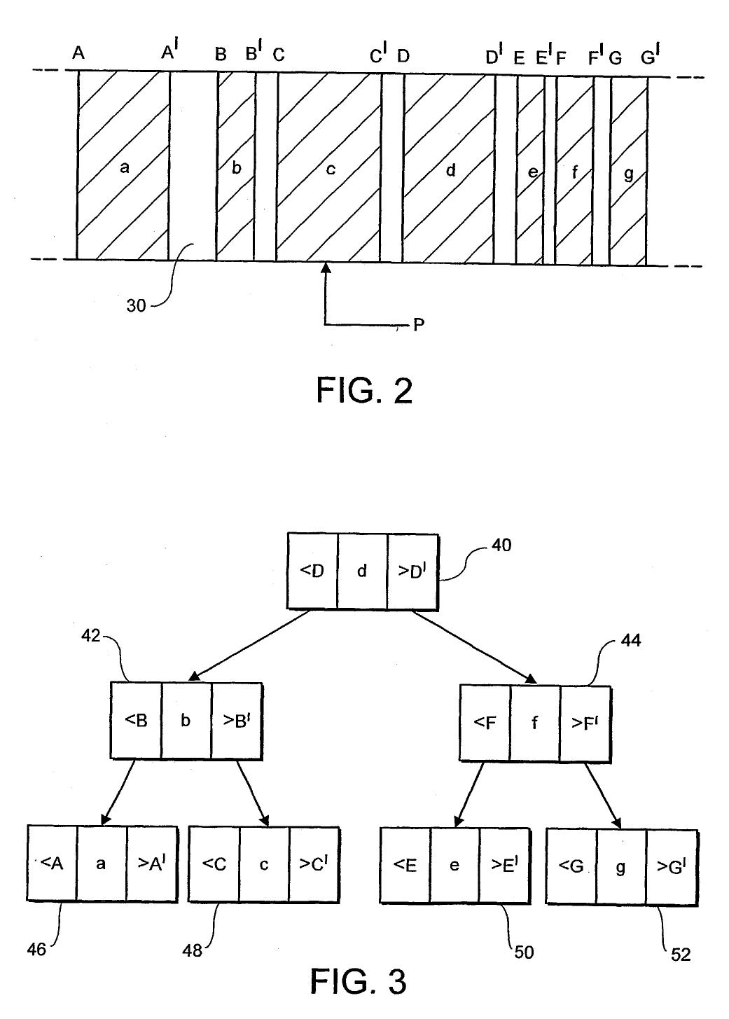

FIG. 2 shows allocated memory blocks, along with an interior pointer to one of those blocks; FIG. 3 is an AVL tree structure for the memory allocations of FIG. 2, according to the preferred embodiment of the invention;

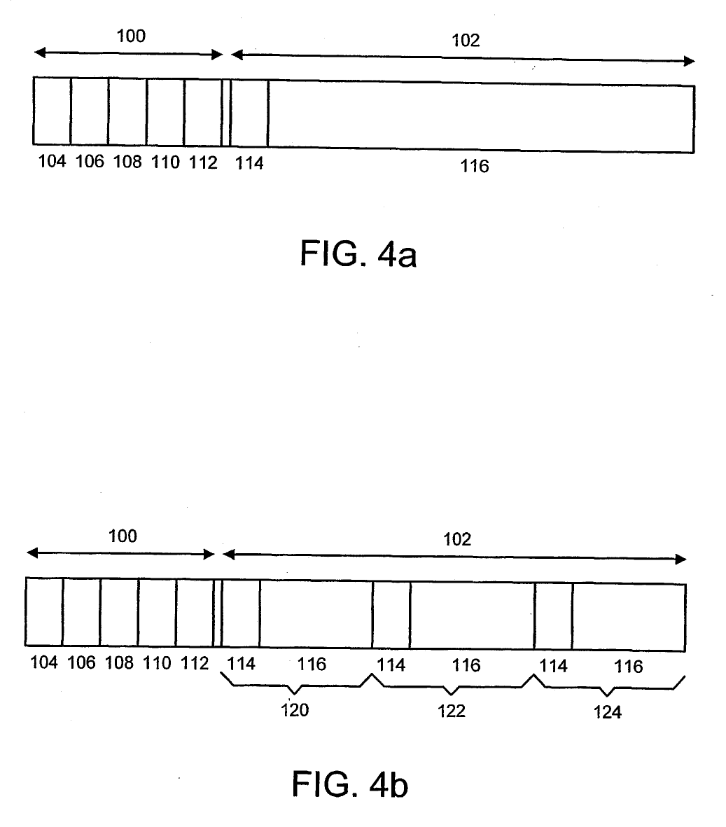

FIG. 4a shows one exemplary memory allocation or “chunk” which forms one of the nodes of the tree; and

FIG. 4b shows an alternative memory allocation, for use when a single “chunk” is used for several individual garbage-collectable allocations.

FIG. 1 illustrates schematically details of register and memory usage in a portion of optimised native code. Data structures 10, 12, 14 represent individual objects, and are held in memory. In addition, machine registers 16 hold additional values, typically pointers to the objects held in memory or to locations within those objects. As indicated in the figure, register 1 holds a pointer 18 (an interior pointer) which points to a particular location within the object 10. Likewise, the registers 2 and 3 hold interior pointers 20, 22 to different locations within the object 14.

Pointers may also be held in memory as shown by the pointer 24. That is an interior pointer within the object 10 which points to an internal location within the object 12.

Not all of the pointers need necessarily be interior. Pointer 26, for example, points to the start of the data structure representing the object 12.

It should be noted that FIG. 1 represents optimised native code which need not, and typically does not, correspond exactly with the way in which the individual objects reference one another in the original language such as Java. Java itself does not have a concept of interior pointers or even, strictly speaking, the concept of pointers at all. Instead, each object can “reference” another object, that reference being to the object as a whole and not to any individual part of it. When the Java code is compiled, those references could be and sometimes are converted into pointers which point to the start of the data structure corresponding to the object in the native code. Native code making use only of such pointers would be inefficient, however, and it is accordingly preferred in the present invention to create interior pointers as necessary. With the interior pointers in place, the original Java pointers which point only to the start of the object data structures can be dropped. As shown in FIG. 1, a pointer such as 26 which points to the start of a data structure is retained only if the code actually needs to reference that address specifically.

FIG. 2 illustrates the storage of data structures in memory, according to the preferred embodiment of the invention. FIG. 2 shows allocated blocks of memory a, b, c . . . , with memory location address increasing as one moves to the right of the figure. Block a starts at memory location A and ends at memory location A′; block b starts at memory location B and ends at memory location B′; and similarly for the other blocks. The spaces between blocks are shown for clarity, and need not necessarily exist.

When a new block of memory needs to be allocated, it is allocated in a convenient memory location, either in an unallocated memory block 30 or, if no such block is available, after the last block g. Allocated memory can be of any size and may be in any position within the addressable memory space. There is no constraint, as in the prior art, of having to allocate memory blocks of particular sizes or in particular predefined locations.

The role of the garbage collector, when run, is to check each of the allocated memory blocks to see whether it may still be required by the application (or, equivalently, whether there is in existence an in-use interior pointer which points to that memory block). In order to achieve that end, whenever a new block of memory is allocated a reference to it is added to a binary tree, held in memory.

FIG. 4a shows in more detail an individual memory block which corresponds to a single node on the tree. The block or “chunk” consists of a header 100 and a data-portion or “payload” 102. The header 100 includes a section 104 which defines the node of the tree with which this particular allocation is associated, a section 106 which indicates whether the allocation is “large” or “small”, a section 108 defining the item size, a section 110 which specifies the start position and a section 112 which specifies the end position. In the FIG. 4a example, the section 106 will always be “large”: the “small” option will be discussed in more detail below with reference to FIG. 4b. The payload 102 includes a header section 114 and a data section 116.

FIG. 3 shows a typical binary tree representing the memory allocations shown in FIG. 2. Each node of the tree represents an individual allocation, and the nodes are linked, as described in more detail below, to allow for efficient searching. The information stored at each node consists of the block identifier (d for the node 40), the start address (D) of the block, the end address (D′). Alternatively, instead of storing D and D′, one could store either the start of the block D or the end of the block D′, along with its length (D′-D).

Each node is also associated with linking information to establish the position of the node within the tree. The node 40, for example, will include the information that it is linked to two children, namely nodes 42 and 44. Node 44 includes the information that it has a parent node 40, and two child nodes 50, 52. The node 52 has no child nodes but a single parent node 44. The linking information associated with each node is labelled or ordered such that the left hand child node can be distinguished from the right hand node.

An example will now be given of the way in which the tree can be searched to identify the memory allocation block to which an unknown interior pointer is pointing. In this example, the unknown pointer will be the pointer P shown in FIG. 2. Entering at the top of the tree, at the node 40, a test is first made to see whether the value of P is less than D. Since P is less than D, we now move to the left hand child node 42 which represents the block b. First, we check whether P is less than B. As it is not, we then go on to check whether P is greater than B′. It is, so we move on to the right hand child block 48. Next, we test whether P is less than C, and as it is not we test whether it is greater than C′. Since P is neither less than C nor greater than C′, we conclude that P falls within the block c, and accordingly the search terminates at the node 48.

Garbage collection is carried out by systematically checking all of the live pointers, and using the tree to determine the memory blocks within which they fall. No distinction for this purpose need be made between interior and other pointers: all are simply searched on the tree in the same way. To start, the registers are checked for pointers (or the stacks in a stack-based system), and the corresponding allocated memory blocks within which they point are determined from the tree. Each of those memory blocks is then checked for further pointers (using tree-based lookup or any other mechanism), and the process is repeated. As the process continues, any memory block that is found to be in use (i.e. that has a pointer which is directed within it) is marked by storing a “in use” flag against the corresponding node of the tree. Memory blocks that are not in use can then be released by the system, and their corresponding nodes removed from the tree. The tree is then re-linked into its normal binary form.

It has been assumed, in the discussion above, that a single memory allocation corresponds with a single node on the tree. In some circumstances, however, it may be more efficient to associate a single node on the tree with several small garbage-collectable allocations. Such an approach is particularly convenient where memory is being allocated from an underlying operating system over which the running application has no control. The system memory allocator will typically provide system allocations (known as “chunks”), the timing and size of which may not be under the control of the application.

As shown in FIG. 4b, a single system allocation or “chunk” may be used for a number of different garbage-collectable allocations—in this example indicated by the reference numerals 120, 122, 124. Each of these units includes its own header 114 and its own data section 116, within the overall chunk payload 102. For ease of comprehension, the reference numerals used in FIG. 4b correspond with those already described above with reference to FIG. 4a.

In the preferred embodiment, the approach of FIG. 4b is used if the application requires a memory allocation of less than 1 k: possible individual allocations are, for example, 32, 64, 128, 256, 512 and 1024 bytes. Where the application requires an allocation of greater than 1 k, the approach of FIG. 4a is used.

In the preferred embodiment, the nodes of the tree represent individual system allocations, either as shown in FIG. 4a or as shown in FIG. 4b, or both. The header and data sections 114, 116 each correspond to a single higher-level garbage collectable allocation, for example a Java allocation.

If the application requires a small allocation (for example less than 1 k in the preferred embodiment), the whole system block is reserved at the same time and put onto the tree. The application itself then controls when and under what circumstances unused small allocations may be accessed and, if appropriate, garbage-collected in their own right without affecting what is on the tree. Only when all of the individual allocations associated with all of the nodes of the tree are no longer in use is the node and the corresponding system block itself available for garbage collection.

It will be understood, of course, that when the approach of FIG. 4b is used, a pointer which points to the start of an individual garbage-collectable allocation will, itself, be an “interior pointer” so far as the entire system block is concerned. The method mentioned above of finding the memory allocation to which an unknown interior pointer is pointing therefore still applies. By referencing the item size section 108 of the header, the system is able to determine the exact garbage-collectable allocation, within the system allocation, to which the interior pointer points.

It remains to be determined where in the tree to insert a new node, when a new block of memory is allocated, and how to re-link the tree when one or more nodes are “snipped out” when the corresponding blocks are released by the garbage collector. There are numerous ways in which this can be done, but one particularly convenient approach is to use an AVL load-balancing tree. This is a type of binary tree which maintains approximate left/right balance by the use of appropriate tree-restructuring algorithms both when adding and when removing nodes. Further details are given, for example, in Donald E. Knuth, The Art of Computer Programming, Volume 3. Addison-Wesley, Reading, Mass., U.S.A, 1969. See also Adelson-Velskii, G. M., and E. M. Landis. “An Algorithm for the Organization of Information”. Soviet Math. Doclady 3, 1962, pp. 1259-1263; and Karlton, P. L., S. H. Fuller, R. E. Scroggs, and E. B. Kaehler. “Performance of Height-Balanced Trees”. Communications of the ACM 19, 1976, pp.23-28. All of these documents are hereby incorporated by reference.

The preferred algorithms, using AVL trees, will now be described in detail. First, a little background. Balanced binary trees are an efficient general purpose data structure. A binary tree is a tree graph each node of which has at most two outgoing edges. Balanced binary trees are structured such that imbalances in size between the two subtrees at any node are limited. AVL trees (after Adelson-Velskii and Landis, who devised the system) are a type of balanced binary tree in which the two subtrees of any node must always have depths which differ by at most 1 level.

The criterion for balance at a node of an AVL tree is that the difference in the height of the two subtrees is never more than one. Height and depth for trees are defined as follows:

The height of a tree with no elements is 0.

The height of a tree with one element is one. The depth of the root node of any tree is 1.

The height of a tree with more than one element is the height of the tallest subtree plus one. The depth of a node in such a tree is the depth of its parent, plus 1.

The ‘balanced’ property of an AVL tree is maintained incrementally in an efficient manner (ie. taking only time logarithmic in the size of the tree). Whenever a node is inserted or removed, one or more rebalancing transformations are applied to the tree.

The three basic operations required are: searching for an element within the tree, inserting an element into the tree and removing an element from the tree. Note that duplicated key values are not permitted, but that this causes no loss of generality since where necessary, an additional factor can be combined with the data to be stored to produce a unique key.

Terminology and Notation

The algorithms are described in terms of ‘nodes’, ‘links’ and ‘keys’. A node is simply a vertex of the tree. Each node has two associated links called the ‘left link’ and the ‘right link’, each of which either points to a subtree or takes the value NULL (by which we mean that there is no subtree to that side). We use ‘Left(N)’ and ‘Right(N)’ to denote the left and right links respectively of a node N. Every node except the root has a unique ‘parent’ node—which is the node one of the links of which points to this node. Each node also has an associated key. We write Key(N) to denote the key associated with node N. A key is simply the data associated with the node. We assume that there exists a total ordering on keys, which we will denote by using the symbol ‘<’. For example, integer values (with the usual meaning of ‘<’) would make suitable keys. We will also require the notion of a ‘direction’. A direction is one of ‘left’, ‘right’ or ‘balanced’. Every node also has an associated direction, for which we write Dir(N) where N is the node in question. We define ‘Link(d,N)’ as a convenient shorthand, where N is a node and d is a direction (not necessarily Dir(N)), to refer to a link from a node. Link(d,N) refers to the left link of node N if d is ‘left’ or to the right link of N if d is ‘right’. If d is ‘balanced’ then the value of Link(d,N) is undefined, but it will never be used in such a context.

If d is a direction then by ‘−d’ we mean the opposite direction. Explicitly, if d is ‘left’ then −d is ‘right’ and vice versa. If d is ‘balanced’ then −d is undefined, but it will never be used in such a context.

In our description of the algorithms, we assume, for clarity, that the root of the tree is not NULL—ie. that the tree is not empty. Obviously, searching and removal always fail on an empty tree and insertion results simply in a tree the root of which is the inserted element.

Note that if a link is referred to in a context in which we would expect a node, it should be taken to refer to the node pointed to by that link.

The Search Algorithm

Step 1) Initialise Variables

Define node P to be initially equal to the root node. Node P will be our ‘current point’ which will be used to traverse the tree.

Define K to be the key we are searching for.

We will also use Q to denote a temporary node, which we will define as needed.

Step 2) Compare

If K<Key(P) go to step 3.

If K>Key(P) go to step 4.

If K=Key(P) then we have found the element we were searching for. (End of Search)

Step 3) Move Left

Set Q to Left(P).

If Q is not now NULL: set P to Q and return to step 2.

The remaining case is if Q is now NULL: this means that the tree did not contain an element with key K, so our search is ended and we return failure. (End of Search)

Step 4) Move Right

Set Q to Right(P).

If Q is not now NULL: set P to Q and return to step 2.

The remaining case is if Q is now NULL: this means that the tree did not contain an element with key K, so our search is ended and we return failure. (End of Search)

The Insertion Algorithm

Step 1) Initialise Variables

Define ‘Head’ to be a special node that is not part of the tree but is considered to be the parent of the root node. Specifically, the right link of Head points to the root. This is done so that we need not regard the root node as a special case for having no parent.

Define nodes S and P to be initially equal to the root node. Node P will be our ‘current point’ which will be used to traverse the tree. Node S will be used to keep track of which subtree should be used as the starting point for rebalancing the tree after insertion.

Define node T to be equal to Head. We will always update T to be the parent of S.

Define K to be the key we are attempting to insert.

We will also use Q and R to denote nodes, which we will define as needed.

Step 2) Compare

If K<Key(P) go to step 3.

If K>Key(P) go to step 4.

If K=Key(P) then an element of that key already exists within the tree and so no insertion is required. (End of Insertion)

Step 3) Move Left

Set Q to Left(P).

If Q is not now NULL: If Dir(Q) is not ‘balanced’ then set T to P and S to Q. Then, whatever the value of Dir(Q), set P to Q and return to step 2.

The remaining case is if Q is now NULL: we insert our new element here. This means that we set Q to be a newly created node (which will have key K), change Left(P) to point to Q and then go to step 5.

Step 4) Move Right

Set Q to Right(P).

If Q is not now NULL: If Dir(Q) is not ‘balanced’ then set T to P and S to Q. Then, whatever the value of Dir(Q), set P to Q and return to step 2.

The remaining case is if Q is now NULL: we insert our new element here. This means that we set Q to be a newly created node (which will have key K), change Right(P) to point to Q and then go to step 5.

Step 5) Insert

Initialise the fields of our new node Q: Set Key(Q) to K, Left(Q) and Right(Q) to NULL, Dir(Q) to ‘balanced’.

Proceed to step 6.

Step 6) Adjust Balance

We need to set the balance directions on the nodes between S and Q to reflect the new state of the tree. This is done as follows:

If K<Key(S) then define d as ‘left’, otherwise, define d as ‘right’.

Set P to Link(d,S) and define a node R to equal P initially.

Repeat the following until P=Q (which may mean 0 times):

1. If K<Key(P) set Dir(P) to ‘left’, then P to Left(P).

2. If K>Key(P) set Dir(P) to ‘right’, then P to Right(P).

3. (If K=Key(P) then it must be the case that P=Q, so proceed)

Proceed to step 7.

Step 7) Balancing

One of three cases applies depending upon the value of Dir(S):

If Dir(S)=‘balanced’ then set Dir(S) to d. In this case the insertion is now completed. (End of Insertion)

If Dir(S) is the opposite of d (ie. is equal to −d) then set Dir(S) to ‘balanced’. In this case the insertion is now completed. (End of Insertion)

If Dir(S)=d the tree has become unbalanced. We determine how to proceed by considering node R (as defined in step 6). If Dir(R) is the opposite of d (ie. is equal to −d) then go to step 9. If Dir(R)=d then go to step 8. Note that it is not possible at this point for either to be ‘balanced’.

Step 8) Single Rotation

We correct an imbalance in the tree as follows:

Set P to R.

Set Link(s,S) to Link(−d,R) then Link(−d,R) to S.

Set Dir(S) and Dir(R) to ‘balanced’.

Go to step 10.

Step 9) Double Rotation

We correct an imbalance to the tree as follows:

Set P to Link(−d,R), then Link(−d,R) to Link(d,P), then Link(d,P) to R.

Set Link(d,S) to Link(−d,P), then Link(−d,P) to S.

Set Dir(S) and Dir(R) depending on the value of Dir(P) as follows:

1. If Dir(P)=d then set Dir(S) to −d and Dir(R) to ‘balanced’.

2. If Dir(P)=−d then set Dir(S) to balanced and Dir(R) to d.

3. If Dir(P)=‘balanced’ then set both Dir(S) and Dir(R) to ‘balanced’ as well.

Go to step 10.

Step 10) Correct Link

Now we have rebalanced the tree, we must make sure that the parent of the rebalanced subtree links to the correct node:

If S=Right(T) then set Right(T) to P, otherwise set Left(T) to P.

Algorithm finished. (End of Insertion)

The Removal Algorithm

Step 1) Initialise variables

Define ‘Head’ to be a special node that is not part of the tree but is considered to be the parent of the root node. Specifically, the right link of Head points to the root. This is done so that we need not regard the root node as a special case for having no parent.

Define P[ ] to be an array of nodes. So we use P[0], P[1] etc. to denote elements within this array.

Similarly, define d[ ] to be an array of directions.

Set P[0] to ‘Head’.

Set d[0] to ‘left’.

Define node P, set initially to Right(P[0]) (ie. to the root node).

Define K to be the key we are attempting to insert.

Define a counter variable c to be an integer, set initially to 1.

We will also use R and S to denote nodes, which we will define as needed, and Q to denote a link (not a node) which we will also define as needed. Note particularly that when we speak of setting Q to some (node) value, we mean to point the link Q at that node.

Step 2) Compare

If K<Key(P) go to step 3.

If K>Key(P) go to step 4.

If K=Key(P) go to step 5.

Step 3) Move Left

Set P[c] to P. Set d[c] to ‘left’.

Add 1 to c.

Set P to Left(P).

If P is NULL then the tree does not contain an element with key K so we stop here. (End of Removal)

Return to step 2.

Step 4) Move Right

Set P[c] to P. Set d[c) to ‘right’.

Add 1 to c.

Set P to Right(P).

If P is NULL then the tree does not contain an element with key K so we stop here. (End of Removal)

Return to step 2.

Step 5) Check Whether Right Link is NULL

Define Q to be Link(d[c−1],P[c−1]), ie. the link which we followed to reach P.

If Right(P)=NULL then proceed to step 6.

Set Q to Left(P).

If Left(P) is not NULL then set Dir(Q) to ‘balanced’ and go to step 10.

Step 6) Find Successor

Set R to Right(P).

If Left(R) is not NULL, go to step 7.

Set Left(R) to Left(P).

Set Q to R.

Set Dir(R) to Dir(P).

Set d[c] to ‘right’. and P[c] to R, then add 1 to c.

Go to step 10.

Step 7) Preparation to Find NULL Left Link

Set S to Left(R) and define integer 1, set initially to c.

Add 1 to c.

Set d[c] to ‘left’ and P[c] to R, then add 1 to c again.

Proceed to step 8.

Step 8) Find NULL Left Link

If Left(S) is NULL, proceed to step 9.

Set R to S, then S to Left(R).

Set d[c] to ‘left’ and P[c] to R, then add 1 to c.

Repeat this step from the beginning (ie. go to step 8).

Step 9) Make Adjustments

Set d[l] to ‘right’ and P[l] to S.

Set Left(S) to Left(P), Left(R) to Left(S) and Right(S) to Right(P).

Set Dir(S) to Dir(P).

Set Q to S.

Step 10) Adjust Balance

Subtract 1 from c.

If c is now 0 then stop here. (End of Removal)

Set S to P[c], then do one of three things depending on Dir(S):

If Dir(S)=‘balanced’, set Dir(S) to −d[c] then stop. (End of Removal)

If Dir(S)=d[c], set Dir(S) to ‘balanced’ and repeat this step from the beginning (ie. go to step 11).

Otherwise Dir(S)=−d[c], so continue with this step.

Set R to Link(−d[c],S).

If Dir(R)=‘balanced’, go to step 11.

If Dir(R)=-d[c], go to step 12.

We must have Dir(R)=d[c]. Go to step 13.

Step 11) Single Rotation with Balanced R

Set Link(−d[c],S) to Link(d[c],R), then Link(d[c],R) to S.

Set Dir(R) to d[c] and Link(d[c−1],P[c−1]) to R.

No further rebalancing is required, so stop. (End of Removal)

Step 12) Single Rotation with Unbalanced R

Set Link(−dfc],S) to Link(d[c],R), then Link(d[c],R) to S.

Set Dir(S) and Dir(R) to ‘balanced’.

Set Link(d[c−1],P[c−1]) to R.

Go to step 10.

Step 13) Double Rotation

Set P to Link(d[c],R), then Link(d[c],R) to Link(−d[c],P), then Link(d[c],P) to R.

Set Link(−d[c],S) to Link(d[c],P) then Link(d[c],P) to S.

Update balance directions depending on the value of Dir(P):

If Dir(P)=−d[c], then set Dir(S)=d[c] and Dir(R)=‘balanced’.

If Dir(P) is ‘balanced’, then set both Dir(S) and Dir(R) to balanced as well.

Otherwise Dir(P)=d[c], so set Dir(S) to 0 and Dir(R) to −d[c].

Set Dir(P) to ‘balanced’ and Link(d[c−1],P[c−1]) to P.

Go to step 10.

The use of a binary tree for garbage collection allows the invention to be used on “hosted” systems, in other words where memory allocation is out of the control of the programmer and is determined by an underlying host operating system. Since the operation of the invention is essentially independent of the memory allocation scheme being used by the underlying operating system, the garbage collector of the invention may be used on top of virtually any underlying operating system that carries out its own memory allocation. Of course, highly efficient memory allocation will normally be achieved only when whichever operating system is carrying out the allocation is capable of making use of the block size and location flexibility described with reference to FIG. 2.

It will be understood that the invention is equally applicable to non-binary (N-way) trees, whether balanced or not. It is applicable, for example, to b-trees. An AVL tree is merely one preferred implementation of a 2-way balanced tree.

1. A method of garbage collection including:
(a) on the creation of a memory allocation, adding a reference to said allocation to a dynamic tree structure comprising a plurality of linked nodes, each node being representative of a respective memory allocation;
(b) for an in-use pointer, searching the tree to determine the memory allocation to which the pointer points; and
(c) noting the said memory allocation as being unavailable for garbage collection release.

2. A method as claimed in claim 1 including repeating steps (b) and (c) for a plurality of in-use pointers, and releasing those memory allocations which have not been noted as unavailable for release.

3. A method as claimed in claim 1 or claim 2 in which the tree is a binary tree.

4. A method as claimed in claim 1 or claim 2 in which the tree is an AVL tree.

5. A method as claimed in any preceding claim in which each memory allocation is a memory block.

6. A method as claimed in claim 5 in which each node has, associated with it, information on the block start and the block end locations; or on one of the said locations and the block length.

7. A method as claimed in any preceding claim in which the in-use pointer is an interior pointer.

8. A method as claimed in any one of preceding claims in which the memory allocations are not necessarily aligned.

9. A garbage collector including:
(a) means for creating memory allocations and for adding a reference to each allocation to a tree structure comprising a plurality of linked nodes, each node being representative of a respective memory allocation;
(b) means for searching the tree, for an in-use pointer, to determine the memory allocations to which the pointer points; and
(c) means for noting the said memory allocations as being unavailable for garbage collection release.

10. A garbage collector as claimed in claim 9 including means for searching for and noting memory allocations for a plurality of in-use pointers, and for releasing these memory allocations which have not been noted as unavailable for release.

11. A garbage collector as claimed in claim 9 or claim 10 in which the tree is a binary tree.

12. A garbage collector as claimed in claim 9 or claim 10 in which the tree is an AVL tree.

13. A garbage collector as claimed in any one of claims 9 to 12 in which each memory allocation is a memory block.

14. A garbage collector as claimed in claim 13 in which each node has, associated with it, information on the block start and the block end locations; or
on one of the said locations and the block length.

15. A garbage collector as claimed in any one of claims 9 to 14 in which the in-use pointer is an interior pointer.

16. A garbage collector as claimed in any one of claims 9 to 15 in which the memory allocations are not necessarily aligned.

17. An operating system including a garbage collector as claimed in any one of claims 9 to 16.

18. An operating system as claimed in claim 17 including memory allocation means.

19. An operating system as claimed in claim 17 which does not include memory allocation means, the garbage collector being arranged to operate with externally-provided memory allocations.

20. An operating system as claimed in claim 19 hosted on an underlying operating system, the externally-provided memory allocations being supplied by a memory allocation means of the underlying operating system.

21. A computer program adapted to carry out a method as claimed in any one of claims 1 to 8.

22. A data carrier carrying a computer program as claimed in claim 21.

23. A data stream which is representative of a computer program as claimed in claim 21.

24. A data carrier carrying an operating system as claimed in any one of claims 17 to 20.

25. A data stream which is representative of an operating system as claimed in any one of claims 17 to 20.

26. A method as claimed in claim 1 or a garbage collector as claimed in claim 9 in which the memory allocations are representative of objects within an object-oriented system.

27. A method or a garbage collector as claimed in claim 26 in which the objects are the compiled forms of Java objects.

28. A method of garbage collection including:
(a) maintaining a tree structure comprising a plurality of linked nodes, each node being representative of a system memory allocation which includes one or more garbage-collectable memory allocations;
(b) for an in-use pointer, searching the tree to determine the garbage-collectable memory allocation to which the pointer points; and
(c) noting the said garbage-collectable memory allocation as being unavoidable for garbage collection release.

29. A garbage collector including:
(a) means for maintaining a tree structure comprising a plurality of linked nodes, each node being representative of a system memory allocation which includes one or more garbage-collectable memory allocations;
(b) means for searching the tree, for an in-use pointer, to determine the garbage-collectable memory allocation to which the pointer points; and
(c) means for noting the said garbage-collectable memory allocation as being unavoidable for garbage collection release.

30. A Java virtual machine including a garbage collector as claimed in any one of claims 9 to 16, or as claimed in claim 29.
